(19) United States
(12) Patent Application Publication
(10) Pub. No.: US 2010/0216420 A1
(43) Pub. Date: Aug. 26, 2010

(54) RADIO FREQUENCY (RF) POWER LIMITER AND ASSOCIATED METHODS

(75) Inventor: Alan William MAST, Melbourne Beach, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Corporation of the State of Delaware, Melbourne, FL (US)

(21) Appl. No.: 12/389,528

(22) Filed: Feb. 20, 2009

(51) Int. Cl. H04B 1/06; G05B 23/02

(52) U.S. Cl. 455/344; 340/3.42

(57) ABSTRACT

A resistive radio frequency (RF) signal power limiter is for connection between an antenna and a receiver circuit in an RF receiver system. The receiver circuit may include a low noise amplifier (LNA). The resistive RF signal power limiter may include at least one positive temperature coefficient (PTC) thermistor connected in series, and at least one negative temperature coefficient (NTC) thermistor connected in shunt between the at least one PTC thermistor and a reference voltage.

### FIELD OF THE INVENTION

The present invention relates to the field of radio frequency (RE) communications, and, more particularly, to a power limiter in an RF receiver and related methods.

### BACKGROUND OF THE INVENTION

Power limiters are commonly used in a variety of communication systems. The basic function of a power limiter is to protect sensitive electronics from RE power above a predetermined value because some devices can be permanently damaged when subjected to an electrical field of a sufficient magnitude. In REF receiving systems, a typical receiver includes a so-called “RF front end” which generally has an antenna coupled to a low noise amplifier (LNA). The amplifier generally is fed to an RF mixer which, in turn, feeds a detector circuit.

It is also known in the art that RF receivers, such as those used in radar systems, for example, typically operate in environments which pose a number of electromagnetic hazards. In such an environment, high RE input signal levels provided by leakage from the radar's transmitter or from hostile jammers for example, pose a threat to those circuit components of a receiving system which are susceptible to burn out as a result of a high incident power level. For example, the LNA used in the RF front end of a radar receiver generally includes at least one field effect transistor which is susceptible to damage due to high incident power levels.

Standard power limiters typically include single or multiple diodes (usually PIN diodes) either in a series or a shunt configuration to reflect and attenuate strong incident RF signals. When used in the series configuration, the diodes are biased off to reflect and attenuate the RF signal, and, when used in the shunt configuration, the diodes are biased on to reflect the RF signal. In either of these configurations, the finite conductance characteristics of the PIN diode causes an undesired reflection and attenuation of the RF signal and undesired non-linear RF signal harmonic generation, that is, during normal operation when the power limiter need not limit power.

One type of PIN-diode RF limiter circuit is described in a paper entitled “Dual-Diode Limiter for High-Power/Low-Spike Leakage Applications” by R. J. Tan et al., published in IEEE MTT-S, Vol. IT, 1990, Page 757. This article describes a limiter having a transmission line with a first end coupled to an input terminal and a second end coupled to an output terminal. At least one, and preferably two or more, PIN diodes are mounted in shunt between the transmission line and a reference potential. Performance is enhanced when two diodes are placed with opposite polarities a quarter wavelength apart along the transmission line. The limiter operates in two basic modes. While operating in its normal, non-limiting mode, the limiter has a relatively low insertion loss. While operating in a power limiting mode however, the PIN diodes are placed in a forward biased conductive state, and as a result, the limiter presents a very high insertion loss characteristic to input power signals. The limiter is placed between the input signal source such as the antenna, for example, and the circuit which needs protection, such as the low noise amplifier.

Also, U.S. Pat. No. 5,126,701 to Adlerstein entitled “Avalanche diode limiters” is directed to an RF limiter circuit including an RF propagation network having a first end coupled to the input terminal of the circuit and a second end coupled to the output terminal of the circuit. The RF limiter circuit further includes a plurality of diodes, with the anode of a first one of the diodes coupled to the RF propagation network and the cathode of a second one of the diodes coupled to the RF propagation network. The limiter circuit further includes a bias network for distributing a reverse bias voltage across each of the plurality of diodes, and for providing a DC voltage on the RE propagation network.

An example of a limiter used for circuit protection is U.S. Pat. No. 6,853,264 to Bennett et al., which discloses a power limiter including a plurality of diodes connected in series to a plurality of transmission lines. The different transmission lines can have varying numbers of the series connected diodes thereby limiting the different transmission lines to different voltage levels. Similarly, U.S. Pat. No. 6,784,837 to Revankar et al. discloses a transmit/receive module including a limiter that uses high breakdown voltage PIN diodes. The limiter operates in conjunction with a transmit/receive switch, which also uses high voltage PIN diodes, and a circulator to provide protection for the receiver circuit.

As noted above, a sensitive system circuit can be protected by a switching device, which serves to isolate the sensitive part of the circuit from exposure to excessive input power. For example, U.S. Pat. No. 6,552,626 to Sharpe et al. discloses a protection system including a PIN diode single-pole, single-throw switch (SPST) isolating the receiver from high power transmission pulses of the transmitter in the event there is a bias failure, such as if the PIN diodes are at a zero bias. The protection system uses one SPST switch assembly between the transmitter and the antenna, and two SPST switch assemblies between the antenna and the receiver to achieve this isolation. Likewise, U.S. Pat. No. 5,446,464 to Feldle discloses a transmit/receive switch connected to a transmitter and receiver signal path. The transmit/receive switch includes two semiconductor diodes, and each semiconductor diode is coupled to an output of a power amplifier. The outputs of the power amplifiers can be selectively connected to ground thereby creating a short circuit.

A conventional diode-based RF limiter may protect the LNA, but distorts the RE signal through the creation of RF harmonics and intermodulation products. High receiver linearity specifications demand better performance while the LNAs need protection. Some LNAs can handle high (e.g. +20 dBm) input signal power, but not for very long, as performance degrades with the extended duration of the high power input signals. So, there is a need for an RF power limiter that does not include the drawbacks of conventional diode limiters discussed above.

### SUMMARY OF THE INVENTION

In view of the foregoing background, it is therefore an object of the present invention to provide an RF power limiter for a receiver that does not create harmonics and distortion like diode limiters.

This and other objects, features, and advantages in accordance with the present invention are provided by a resistive radio frequency (RF) signal power limiter for connection between an antenna and a receiver circuit in an RF receiver system. The receiver circuit may include a low noise amplifier (LNA). The resistive RF signal power limiter may include at least one positive temperature coefficient (PTC) thermistor connected in series between the antenna and a receiver circuit, and at least one negative temperature coefficient (NTC) thermistor connected in shunt between the at least one PTC thermistor and a reference voltage. The resistive RF signal power limiter does not create the harmonic and intermodulation distortion, for example, as do diode-based limiters.

The resistive RF signal power limiter may further comprise a resistive device connected in parallel with the at least one NTC thermistor. The resistive device and the NTC thermistor may be thermally coupled. The resistive REF signal power limiter may further comprise a microstrip substrate carrying the PTC thermistor, the NTC thermistor and the resistive device.

In one embodiment, the resistive RF signal power limiter may further comprise a first NTC thermistor connected to an upstream side of the at least one PTC thermistor, and a second NTC thermistor connected to a downstream side of the at least one PTC thermistor. The resistive RF signal power limiter may further include a first resistive device connected in parallel with the first NTC thermistor, and a second resistive device connected in parallel with the second NTC thermistor. Such first and second resistive devices may be respectively thermally coupled to the first and second NTC thermistors.

In another embodiment, the at least one PTC thermistor may comprise first and second series connected PTC thermistors. The NTC thermistor is connected in shunt to a reference voltage between the first and second series connected PTC thermistors. The resistive RF signal power limiter may further comprise a resistive device connected in parallel with the at least one NTC thermistor.

A method aspect is directed to making a resistive RF signal power limiter for connection between an antenna and a receiver circuit of a radio frequency (RF) receiver system The method may include providing at least one positive temperature coefficient (PTC) thermistor for connection in series between the antenna and the receiver circuit, and connecting at least one negative temperature coefficient (NTC) thermistor in shunt between the at least one PTC thermistor and a reference voltage.

The method may further include connecting a resistive device in parallel with the at least one NTC thermistor and thermally coupled thereto. Also, a microstrip substrate may be provided to carry the PTC thermistor, the NTC thermistor and the resistive device.

In one embodiment of the method, a first NTC thermistor may be connected to an upstream side of the at least one PTC thermistor, and a second NTC thermistor may be connected to a downstream side of the at least one PTC thermistor. The method may include connecting a first resistive device in parallel with the first NTC thermistor and thermally coupled thereto, and connecting a second resistive device to the reference voltage and thermally coupled in parallel with the second NTC thermistor and thermally coupled thereto.

In another embodiment, first and second PTC thermistors may be connected in series. The at least one NTC thermistor may be connected to the reference voltage between the first and second series connected PTC thermistors. A resistive device may be connected in parallel with the at least one NTC thermistor and thermally coupled thereto.

### BRIEF DESCRIPTION OF THE DRAWINGS

FIG. 1 is schematic diagram of a conventional power limiter or Pi-attenuator in accordance with the prior art.

FIG. 2 is a schematic diagram of an embodiment of an RF signal power limiter in accordance with the present invention.

FIG. 3 is a schematic block diagram illustrating an RF receiver system including an RF signal power limiter in accordance with the present invention.

FIG. 4 is a graph illustrating an example of input power versus output power for a receiver circuit with/without the limiter of FIG. 2.

FIG. 5 is a perspective view of a microstrip embodiment of the RF signal power limiter in accordance with an embodiment of the present invention.

FIG. 6 is a schematic diagram of another embodiment of an RF signal power limiter in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

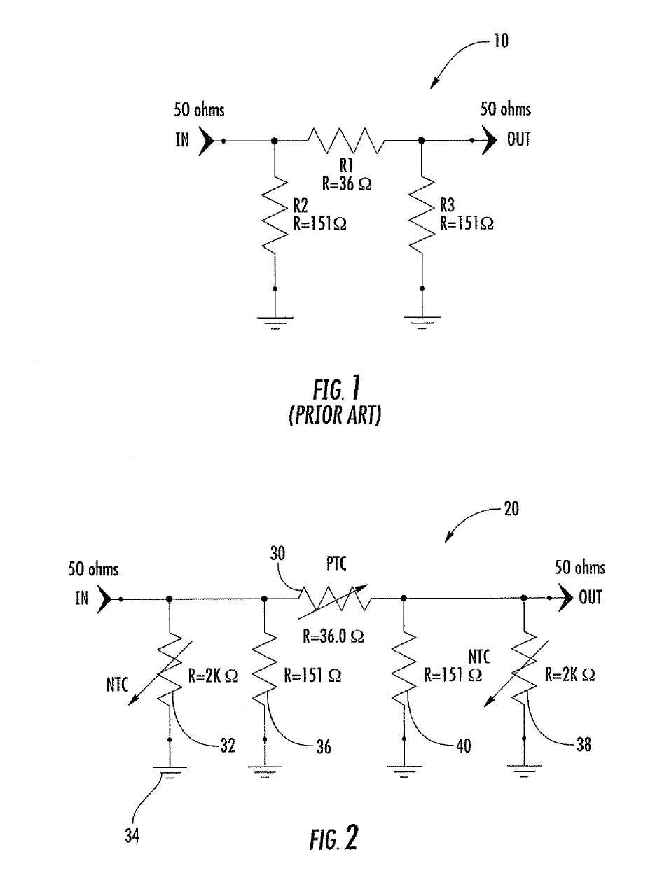

Referring initially to FIG. 1, a common attenuator circuit 10, known as the “pi attenuator network,” is illustrated. An attenuator is an electronic device that reduces the amplitude or power of a signal without appreciably distorting its waveform. An attenuator is effectively the opposite of an amplifier, though the two work by different methods. While an amplifier provides gain, an attenuator provides loss, or gain less than 1. Perhaps the most common use of such an attenuator circuit 10 is in a receiver circuit, such as a 50 ohm circuit.

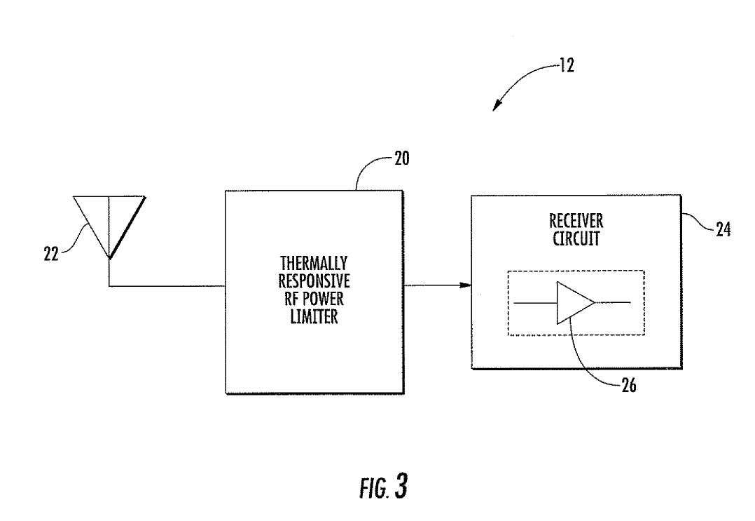

Referring now to FIGS. 2 and 3, a resistive radio frequency (RF) signal power limiter 20 for connection between an antenna 22 and a receiver circuit 24 in an RF receiver system 12 in accordance with the invention will now be described. Other elements, such as a beamformer, may also be connected between the receiver circuit 24 and the antenna 22. And the antenna 22 may include many antenna elements, such as in a phased array arrangement as would be appreciated by those skilled in the art. Such a receiver circuit 24 may include a low noise amplifier (LNA) 26. In general, the resistive RF signal power limiter 20 includes at least one positive temperature coefficient (PTC) thermistor 30 connected in series, and at least one negative temperature coefficient (NTC) thermistor 32 connected in shunt between the at least one PTC thermistor and a reference voltage (e.g. ground) 34. The resistive RE signal power limiter 20 may further include a resistive device 36 connected to the reference voltage 34 and in parallel with the NTC thermistor 32. The resistive device 36 and the NTC thermistor 32 may be thermally coupled. The exemplary resistance values for a 6 dB power reduction in a 50 ohm REF receiver circuit are indicated.

A thermistor is a type of resistor with resistance varying according to its temperature.

Thermistors are widely used as inrush current limiters, temperature sensors, self-resetting overcurrent protectors, and self-regulating heating elements. Assuming, as a first-order approximation, that the relationship between resistance and temperature is linear, then: ΔR=kΔT; where ΔR=change in resistance, ΔT=change in temperature, and k=first-order temperature coefficient of resistance.

Thermistors can be classified into two types depending on the sign of k. If k is positive, the resistance increases with increasing temperature, and the device is called a positive temperature coefficient (PTC) thermistor, or posistor. If k is negative, the resistance decreases with increasing temperature, and the device is called a negative temperature coefficient (NTC) thermistor. Resistors that are not thermistors are designed to have a k as close to zero as possible, so that their resistance remains nearly constant over a wide temperature range.

In the illustrated embodiment, the resistive RF signal power limiter 20 includes a first NTC thermistor 32 connected in shunt between an upstream side of the PTC thermistor 30 and the reference voltage 34, and a second NTC thermistor 38 connected in shunt between a downstream side of the PTC thermistor 30 and the reference voltage 34. The resistive RF signal power limiter 20 also illustratively includes a first resistive device 36 connected to the reference voltage 34 and in parallel with the first NTC thermistor 32, and a second resistive device 40 connected to the reference voltage 34 and in parallel with the second NTC thermistor 38. Such first and second resistive devices 36, 40 may be respectively thermally coupled to the first and second NTC thermistors 32, 38.

Below is a table of attenuation values versus temperature for an example of a resistive RF power limiter 20 in accordance with features of the present invention. As temperature increases, as seen from left to right on the below table, the representative PTC posistor increases in resistance values while the NTC thermistor decreases greatly in resistance value. Since the NTC thermistor is in parallel with a standard resistor as shown in 20, the resistance from the two elements combine to create the total Eshunt resistance value as shown in fourth row. The combined effect of the posistor changes and Rshunt changes results in a signal attenuator variation of 5.8 dB at cold temperatures to 12.2 dB at the high end of the given temperature scale. The last row in the table illustrates the RF attenuator circuit return loss with respect to 50 ohm impedance RF system which shows that the reflection from the attenuator increases slightly at higher temperatures although −15.8 dB still represents a good match to the surrounding components in the 50 ohm system.

Attenuation values vs. temperature

| | | | | | | | | |
|---|---|---|---|---|---|---|---|---|
| Temperature | −20 | 0 | 25 | 40 | 60 | 80 | 100 | C. |
| Posistor | 35 | 33 | 31 | 30 | 31 | 33 | 66 | ohms |
| values | | | | | | | | |
| Thermistor | 28842 | 7974 | 2000 | 970 | 410 | 191 | 98 | ohms |
| Values | | | | | | | | |
| Rshunt total | 150 | 147 | 139 | 130 | 110 | 84 | 59 | ohms |
| resist. | | | | | | | | |
| Pad/Limiter | 5.8 | 5.72 | 5.9 | 6.1 | 6.67 | 7.7 | 12.2 | dB |
| Value (dB) | | | | | | | | |
| Return Loss | −30 | −28 | −26 | −24 | −20 | −16 | −15.8 | dB |

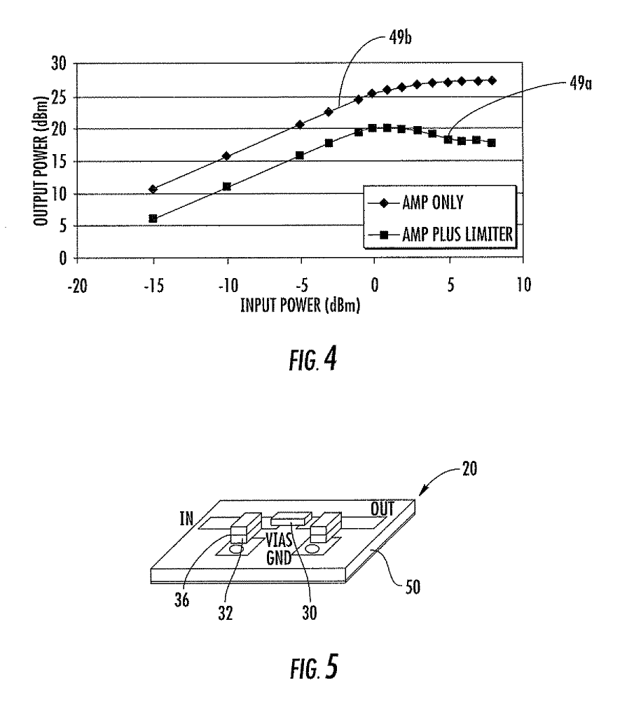

The following table indicates various measurements from an example of a resistive REF power limiter 20 in accordance with features of the present invention. For these measurements a power amplifier is used to increase the power levels higher than that of the RF signal generator source. As the input power from the RE source is increased, shown in column 1, the output power from the amplifier is increased, shown in column 2, until the amplifier's maximum output power of 27.25 dBm the is reached, as measured on an RF power meter. The attenuator configured as in resistive RF power limiter 20 is placed after the amplifier and it's output signal power, shown in column 3, is measured on an RF power meter. The difference between the two measurements, column 4, is the attenuation value of the presented RF power limiting attenuator. As power levels are increased, the attenuator's value stays relatively unchanged until its incident power reaches the 24.43 dBm mark, where it begins to increase its attenuation appreciably with increased input power levels. The measurements listed in this table are graphed in FIG. 4.

Thermal Attenuator measurements

| | dBm | dBm | dB |
|---|---|---|---|
| dBm | Amp only | Amp + atten | Atten |
| Input Power | Output Power | Output Power | Value |
| −15 | 10.65 | 5.85 | 4.8 |
| −10 | 15.61 | 10.8 | 4.81 |
| −5 | 20.61 | 15.75 | 4.86 |
| −3 | 22.58 | 17.62 | 4.96 |
| −1 | 24.43 | 19.21 | 5.22 |
| 0 | 25.27 | 19.75 | 5.52 |
| 1 | 25.91 | 20.06 | 5.85 |
| 2 | 26.38 | 19.93 | 6.45 |
| 3 | 26.73 | 19.42 | 7.31 |
| 4 | 26.92 | 18.86 | 8.06 |
| 5 | 27.05 | 18.26 | 8.79 |
| 6 | 27.14 | 17.92 | 9.22 |
| 7 | 27.21 | 17.9 | 9.31 |
| 8 | 27.25 | 17.56 | 9.69 |

Referring now additionally to FIG. 4, the graph illustrates respective example plots 49a, 49b of input power versus output power for a receiver circuit with/without the limiter 20 of FIG. 2.

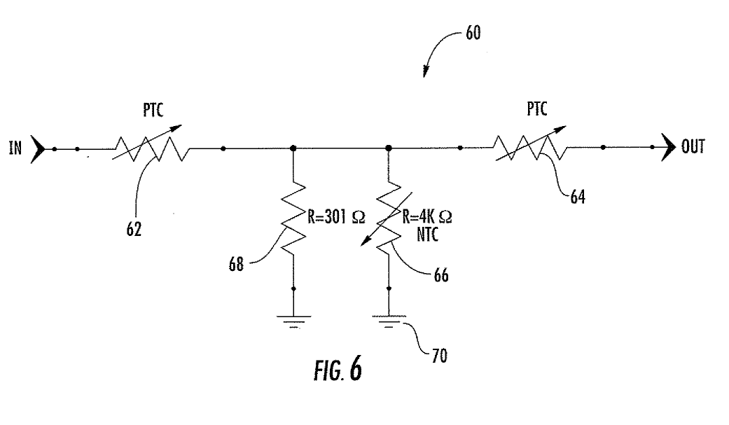

Referring additionally to FIG. 5, the resistive RF signal power limiter 20 may further comprise a substrate 50 carrying at least the PTC thermistor 30, the NTC thermistor 32 and the resistive device 36. Such an embodiment may use a stripline or microstrip arrangement. A stripline circuit uses a flat strip of metal which is sandwiched between two parallel ground planes, the insulating material of the substrate forms a dielectric. The width of the strip, the thickness of the substrate and the relative permittivity of the substrate determine the characteristic impedance of the strip which is a transmission line. The dielectric material may be different above and below the central conductor. Like coaxial cable, stripline is non-dispersive, and has no cutoff frequency. Good isolation between adjacent traces can be achieved. A microstrip is similar to stripline transmission line except that the microstrip is not sandwiched, it is on a surface layer, above a ground plane. Such an embodiment may be formed with chip resistors/thermistors.

Chip resistors are passive resistors with a form factor of an integrated circuit (IC) chip. Typically, they are manufactured using thin-film technology. There are two basic configurations for chip resistors: a single resistor configuration and a resistor chip array configuration. Single chip resistors are standard, passive resistors with a single resistance value. Resistor chip arrays contain several resistors in a single package. For both configurations, performance specifications include resistance range, tolerance, temperature coefficient of resistance (TCR), power rating, operating direct current (DC) voltage, current rating and operating resistors. For resistor chip arrays, the number of resistors in the package is also an important parameter to consider.

Chip resistors may be made from many different materials. Carbon-composition resistors include powdered carbon, an insulating material, and a resin binder. Cermet resistors are made of ceramic and metallic materials. Carbon film, ceramic composition, metal alloy, metal foil, tantalum, and wirewound chip resistors are also commonly available. Metal-film resistors are produced by depositing a resistive element onto a high-grade, ceramic rod. They are similar, but not identical to metal-oxide resistors. Thick-film chip resistors are made by stenciling a resistive metallic paste or ink onto a base in a process similar to silk screening. By contrast, thin-film chip resistors are formed by vapor-deposition and then trimmed to a specific value.

In another embodiment, with reference to FIG. 6, first and second series connected PTC thermistors 62, 64 may be provided. The NTC thermistor 66 is connected to the reference voltage 70 between the first and second series connected PTC thermistors. The resistive RF signal power limiter 60 may further comprise a resistive device 68 connected to the reference voltage 70 and in parallel with the NTC thermistor 66.

A method aspect is directed to making a resistive RF signal power limiter 20 for connection between an antenna 22 and a receiver circuit 24 of a radio frequency (RF) receiver system 12. The method includes providing at least one positive temperature coefficient (PTC) thermistor 30 for connection in series between the antenna 22 and the receiver circuit 24, and connecting at least one negative temperature coefficient (NTC) thermistor 32 in shunt between the PTC thermistor 30 and a reference voltage 34.

The method may further include connecting a resistive device 36 to the reference voltage 34 and thermally coupled in parallel with the NTC thermistor 32. Also, a substrate 50 may be provided to carry the PTC thermistor 30, the NTC thermistor 32 and the resistive device 36.

In one embodiment of the method, the first NTC thermistor 32 may be connected in shunt between an upstream side of the PTC thermistor 30 and the reference voltage 34, and a second NTC thermistor 38 may be connected in shunt between a downstream side of the PTC thermistor 30 and the reference voltage 34. The method may include connecting the first resistive device 36 to the reference voltage 34 and thermally coupled in parallel with the first NTC thermistor 32, and connecting a second resistive device 40 to the reference voltage 34 and thermally coupled in parallel with the second NTC thermistor 38.

In another embodiment, first and second PTC thermistors 62, 64 may be connected in series. The NTC thermistor 66 may be connected to the reference voltage 70 between the first and second series connected PTC thermistors 62, 64. A resistive device 68 may be connected to the reference voltage 70 and thermally coupled in parallel with the NTC thermistor 66.

The passive resistive devices and thermistors in the present approach do not create harmonics and distortion like the conventional semiconductor diode limiters. The use of NTC and PTC thermistors increases path attenuation versus signal level, For example, as the power increases, the temperature increases due to the dissipated power, which then acts to change the resistance of the thermistors. The incident signal level at the receiver circuit and LNA is decreased through the additional attenuation and reflection.

Additionally, due to the mature deposition and printing methods of manufacturing thin and thick film resistor and thermistor materials, various alternate embodiments of this invention exist. For instance, a thermistor material may be printed on an insulative material, as in a conventional chip thermistor, and then a thin insulative layer applied, over which a resistive layer is applied. This would result in a single chip component with the same functionality of both chip components 32 and 36 in FIG. 5. Additionally, this intimate contact of the resistive layers would also efficiently transfer heat from the resistor element to the thermistor element, which may create the limiting mechanism for this attenuator.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A radio frequency (RF) receiver system comprising:
an antenna;
a receiver circuit; and
a resistive RF signal power limiter connected between said antenna and said receiver circuit, and comprising
at least one positive temperature coefficient thermistor connected in series between said antenna and said receiver circuit, and
at least one negative temperature coefficient thermistor connected in shunt between the at least one positive temperature coefficient thermistor and a reference voltage.

2. The REF receiver system according to claim 1, wherein the resistive RF signal power limiter further comprises a resistive device connected in parallel with the at least one negative temperature coefficient thermistor.

3. The RE receiver system according to claim 2, wherein the resistive device and the negative temperature coefficient thermistor are thermally coupled.

4. The RF receiver system according to claim 3, wherein the resistive REF signal power limiter further comprises a microstrip substrate carrying said positive temperature coefficient thermistor, said negative temperature coefficient thermistor and said resistive device.

5. The RF receiver system according to claim 1, wherein the at least one negative temperature coefficient thermistor of said resistive RF signal power limiter comprises:
a first negative temperature coefficient thermistor connected to an upstream side of the at least one positive temperature coefficient thermistor; and
a second negative temperature coefficient thermistor connected to a downstream side of the at least one positive temperature coefficient thermistor.

6. The RF receiver system according to claim 5, wherein the resistive RF signal power limiter further comprises:
a first resistive device connected in parallel with the first negative temperature coefficient thermistor; and
a second resistive device connected in parallel with the second negative temperature coefficient thermistor.

7. The RF receiver system according to claim 6, wherein the first and second resistive devices are respectively thermally coupled to the first and second negative temperature coefficient thermistors.

8. The RF receiver system according to claim 1 wherein the at least one positive temperature coefficient thermistor comprises first and second series connected positive temperature coefficient thermistors; and wherein the at least one negative temperature coefficient thermistor is connected between the first and second series connected positive temperature coefficient thermistors.

9. The RF receiver system according to claim 8, wherein the resistive RF signal power limiter further comprises a resistive device connected in parallel with the at least one negative temperature coefficient thermistor and thermally coupled thereto.

10. The REF receiver system according to claim 1 wherein the receiver circuit includes a low noise amplifier (LNA).

11. A resistive RF signal power limiter for connection between an antenna and a receiver circuit of a radio frequency (RF receiver system, the resistive RF signal power limiter comprising:
at least one positive temperature coefficient thermistor to be connected in series between said antenna and said receiver circuit; and
at least one negative temperature coefficient thermistor to be connected in shunt between the at least one positive temperature coefficient thermistor and a reference voltage.

12. The resistive REF signal power limiter according to claim 11, further comprising a resistive device to be connected to the reference voltage and thermally coupled in parallel with the at least one negative temperature coefficient thermistor and thermally coupled thereto.

13. The resistive RF signal power limiter according to claim 12, further comprising a microstrip substrate carrying said positive temperature coefficient thermistor, said negative temperature coefficient thermistor and said resistive device.

14. The resistive RE signal power limiter according to claim 11, wherein the at least one negative temperature coefficient thermistor comprises:
a first negative temperature coefficient thermistor connected to an upstream side of the at least one positive temperature coefficient thermistor; and
a second negative temperature coefficient thermistor connected to a downstream side of the at least one positive temperature coefficient thermistor.

15. The resistive RF signal power limiter according to claim 14, further comprising:
a first resistive device connected in parallel with the first negative temperature coefficient thermistor and thermally coupled thereto; and
a second resistive device connected in parallel with the second negative temperature coefficient thermistor and thermally coupled thereto.

16. The resistive RF signal power limiter according to claim 11, wherein the at least one positive temperature coefficient thermistor comprises first and second series connected positive temperature coefficient thermistors; and wherein the at least one negative temperature coefficient thermistor is connected between the first and second series connected positive temperature coefficient thermistors.

17. The resistive RF signal power limiter according to claim 18, further comprising a resistive device connected in parallel with the at least one negative temperature coefficient thermistor and thermally coupled thereto.

18. A method of using a resistive RF signal power limiter for connection between an antenna and a receiver circuit of a radio frequency (RF) receiver system, the method comprising:
providing at least one positive temperature coefficient thermistor for connection in series between the antenna and the receiver circuit; and
connecting at least one negative temperature coefficient thermistor in shunt between the at least one positive temperature coefficient thermistor and a reference voltage.

19. The method according to claim 18, further comprising connecting a resistive device in parallel with the at least one negative temperature coefficient thermistor and thermally coupled thereto.

20. The method according to claim 19, further comprising providing a microstrip substrate to carry the positive temperature coefficient thermistor, the negative temperature coefficient thermistor and the resistive device.

21. The method according to claim 18, wherein connecting the at least one negative temperature coefficient thermistor comprises:
connecting a first negative temperature coefficient thermistor to an upstream side of the at least one positive temperature coefficient thermistor; and
connecting a second negative temperature coefficient thermistor to a downstream side of the at least one positive temperature coefficient thermistor.

22. The method according to claim 21, further comprising:
connecting a first resistive device in parallel with the first negative temperature coefficient thermistor and thermally coupled thereto; and
connecting a second resistive device in parallel with the second negative temperature coefficient thermistor and thermally coupled thereto.

23. The method according to claim 18, wherein providing the at least one positive temperature coefficient thermistor comprises connecting first and second positive temperature coefficient thermistors in series; and wherein the at least one negative temperature coefficient thermistor is connected between the first and second series connected positive temperature coefficient thermistors.

24. The method according to claim 23, further comprising connecting a resistive device in parallel with the at least one negative temperature coefficient thermistor and thermally coupled thereto.
